(19) United States
(12) Patent Application Publication
(10) Pub. No.: US 2007/0295145 A1
(43) Pub. Date: Dec. 27, 2007

(54) Steering device

(75) Inventors: Yoshiyuki Sekii, Fujisawa-Shi (JP); Tetsuya Koike, Bennington, VT (US)

Correspondence Address: SIDLEY AUSTIN LLP, 717 NORTH HARWOOD, SUITE 3400, DALLAS, TX, 75201, US

(73) Assignee: NSK LTD.

(21) Appl. No.: 11/807,304

(22) Filed: May 25, 2007

(30) Foreign Application Priority Data
May 30, 2006 (JP) 2006-149727

(51) Int. Cl. B62D 1/18; B62D 1/16

(52) U.S. Cl. 74/493; 280/775

(57) ABSTRACT

There is provided a steering device which allows the telescopic position of a movable column member to be steplessly adjusted, does not require a large force to operate a control lever for clamping, and prevents the movable column member from moving toward the vehicle front when a large impact force of a secondary collision is applied. The column clamp clamps by friction using wedges, making the movable column member position steplessly adjustable. The positive column clamp having the first and second toothed members clamps in steps defined by the engagement tooth pitch, so that the engagement between the first and second toothed members may be displaced. The swing lever attached to the second toothed member slides, guided by the swing center shaft, a distance equal to the engagement displacement along the axis of the first toothed member, enabling the second toothed member to correctly engage the first toothed member.

### FIELD OF THE INVENTION

The present invention relates to a steering device, particularly, to a steering device for a vehicle, the steering device having a telescopic mechanism.

### BACKGROUND OF THE INVENTION

The telescopic mechanism is for adjusting the position in the vehicle front-rear direction of the steering wheel of a vehicle according to the physique and preferences of the driver to enable the driver to operate the steering wheel most comfortably.

The telescopic mechanism has a column clamp which is clamped and unclamped when adjusting the position in the vehicle front-rear direction of the steering wheel. Namely, when telescopically adjusting the position in the vehicle front-rear direction of the steering wheel, the column clamp is once unclamped. After the position in the vehicle front-rear direction of the steering wheel is adjusted, the column clamp is clamped again.

Generally, a column clamp of the above type clamps, by friction, a movable column member to a fixed column member at a desired stepless telescopic position using a movable wedge and a fixed wedge each having a slope, the slopes of the two wedges engaging each other. Therefore, if, at a time of a secondary collision, a large impact force is applied to the steering wheel in the direction toward the vehicle front, the movable column member is moved toward the vehicle front opposing the friction force applied by the column clamp. As a result, the movable column member collides with the fixed column member and the driver is subjected to a large impact force.

Increasing the clamping force of the column clamp that depends on a friction force for clamping so as to prevent the movable column member from moving toward the vehicle front at a time of a secondary collision largely increases the force required to operate the control lever for the column clamp and degrades the control lever operability.

A steering device equipped with a column clamp which is designed to prevent a movable column from moving toward the vehicle front when subjected to an impact force at a time of a secondary collision and which does not require a large operating force to operate the control lever is proposed in Japanese Unexamined Utility Model Application Publication No. JP 5(1993)-49564 U.

The steering device proposed in JP 5(1993)-49564 U includes a telescopically movable column member and a fixed column member. The movable column member has a plurality of fixed ratchet teeth successively formed in the axial direction on an outer circumferential surface thereof. The fixed column member has ratchet teeth displaceably provided thereon. The displaceable ratchet teeth engage the fixed ratchet teeth to prevent the movable column member from moving toward the vehicle front.

The steering device proposed in JP 5(1993)-49564 U can prevent the movable column member from moving toward the vehicle front when subjected to an impact force at a time of a secondary collision. In the steering device, however, the position of the movable column member is telescopically adjustable only in steps based on the ratchet tooth pitch in the axial direction. It is not possible to steplessly adjust the telescopic position of the movable column member.

### SUMMARY OF THE INVENTION

An object of the present invention is to provide a steering device which allows the telescopic position of a movable column member to be steplessly adjusted, which does not require a large force to operate a control lever for clamping, and which prevents the movable column member from moving toward the vehicle front when subjected to a large impact force at a time of a secondary collision.

The above object is achieved as follows. The first invention provides a steering device which comprises a fixed column member having a body attaching part for attaching the steering device to a vehicle body, a movable column member fitted to the fixed column telescopically movably in a vehicle front-rear direction, a steering shaft which is rotatably supported by the movable column member and to one end of which a steering wheel is fixed, and a column clamp for clamping and unclamping the movable column member to and from the fixed column member at a desired telescopic position. The steering device further comprises a first toothed member on which a plurality of engagement teeth are formed over a longitudinal length at least equal to a distance over which the telescopic position is adjustable, a second toothed member having at least one engagement tooth engageable with the engagement teeth of the first toothed member, and an engagement control member for engaging and disengaging the second toothed member with and from the first toothed member. In the steering device, the first toothed member is provided on one of the fixed column member and the movable column member and the second toothed member is provided on the other of the fixed column member and the movable column member. Also in the steering device, one of the first toothed member and the second toothed member is movable relative to one of the fixed column member and the movable column member by a distance equivalent to a pitch of the engagement teeth of the first toothed member.

The second invention provides a steering device according to the first invention, wherein the engagement teeth of the first and second toothed members engage each other with an angle smaller than a friction angle for preventing disengagement of the teeth when an impact of a secondary collision is applied.

The third invention provides a steering device according to the first invention, wherein the second toothed member is swingable about and slidable along an axis parallel to a center axis of the fixed column member.

The fourth invention provides a steering device according to the first invention, wherein the first toothed member is provided with a predetermined range of rotational play about the axis parallel to the center axis of the fixed column member.

The fifth invention provides a steering device according to the first invention, wherein the steering device further comprises a single control lever for interlockingly controlling the column clamp and the engagement control member.

The sixth invention provides a steering device according to the first invention, wherein the column clamp has a movable wedge and a fixed wedge each having a slope, the slopes of the movable wedge and the fixed wedge engaging each other to clamp and unclamp the movable column member to and from the fixed column member at a desired telescopic position.

The seventh invention provides a steering device according to the sixth invention, wherein the first toothed member is provided with a predetermined distance of play in a direction of the column clamp pressing.

The steering device according to the present invention includes a first toothed member on which a plurality of engagement teeth are formed over a longitudinal length at least equal to a distance over which the telescopic position is adjustable, a second toothed member having at least one engagement tooth engageable with the engagement teeth of the first toothed member, and an engagement control member for engaging and disengaging the second toothed member with and from the first toothed member. The first toothed member is provided on one of the fixed column member and the movable column member and the second toothed member is provided on the other of the fixed column member and the movable column member. One of the first toothed member and the second toothed member is movable relative to one of the fixed column member and the movable column member by a distance equivalent to a pitch of the engagement teeth of the first toothed member.

Therefore, an engagement displacement occurring between the first and the second toothed members made up for as one of the first and the second toothed members moves in the vehicle front-rear direction to absorb the engagement displacement. This makes it possible to combinedly effect stepless clamping by friction and stepwise clamping by means of engagement teeth. Hence, the steering device according to the present invention allows the telescopic position of a movable column member to be steplessly adjusted; does not require a large force to operate a control lever for clamping; and prevents the movable column member from moving toward the vehicle front when subjected to a large impact force at a time of a secondary collision.

### BRIEF DESCRIPTION OF THE DRAWINGS

FIG. 1 is an external view of a steering device 1 according to a first embodiment of the present invention.

FIG. 2 is a top view showing the steering device 1 as seen in the direction of arrow P in FIG. 1.

FIG. 3 is a bottom view of the steering device 1 as seen in the direction of arrow Q in FIG. 1.

FIG. 4 is an enlarged side view showing an essential part of the steering device 1.

FIG. 5 is an enlarged partly-cross-sectional bottom view corresponding to FIG. 3.

FIG. 6 is a cross-sectional view taken along line A-A in FIG. 1.

FIG. 7 is a cross-sectional view taken along line B-B in FIG. 1.

FIG. 8 is a side view showing an essential part of a column clamp.

FIG. 9 is a cross-sectional view taken along line C-C in FIG. 5 in which the column clamp is shown.

FIG. 10 is an exploded view of the column clamp in a sub-assembled state.

FIG. 11 is a cross-sectional view taken along line D-D in FIG. 1.

FIG. 12(1) is a cross-sectional view taken along line E-E in FIG. 4.

FIG. 12(2) is a cross-sectional view taken along line F-F in FIG. 4.

FIG. 13 is an exploded perspective view showing a swing lever and a swing lever retention spring.

FIG. 14(1) is an operation diagram showing a bias direction reversing mechanism 81 with a control lever 7 in an end position a for clamping.

FIG. 14(2) is an operation diagram showing the bias direction reversing mechanism 81 with the control lever 7 in an end position b for unclamping.

FIG. 15(1) is a part drawing showing a front view of a first toothed member alone used in the first embodiment.

FIG. 15(2) is a part drawing showing a bottom view corresponding to FIG. 15(1).

FIG. 16(1) is a part drawing showing a front view of a first toothed member alone used in a second embodiment of the present invention.

FIG. 16(2) is a part drawing showing a bottom view corresponding to FIG. 16(1).

### DETAILED DESCRIPTION OF THE PREFERRED EMBODIMENTS

In the following, first and second embodiments of the present invention will be described with reference to the accompanying drawings.

### First Embodiment

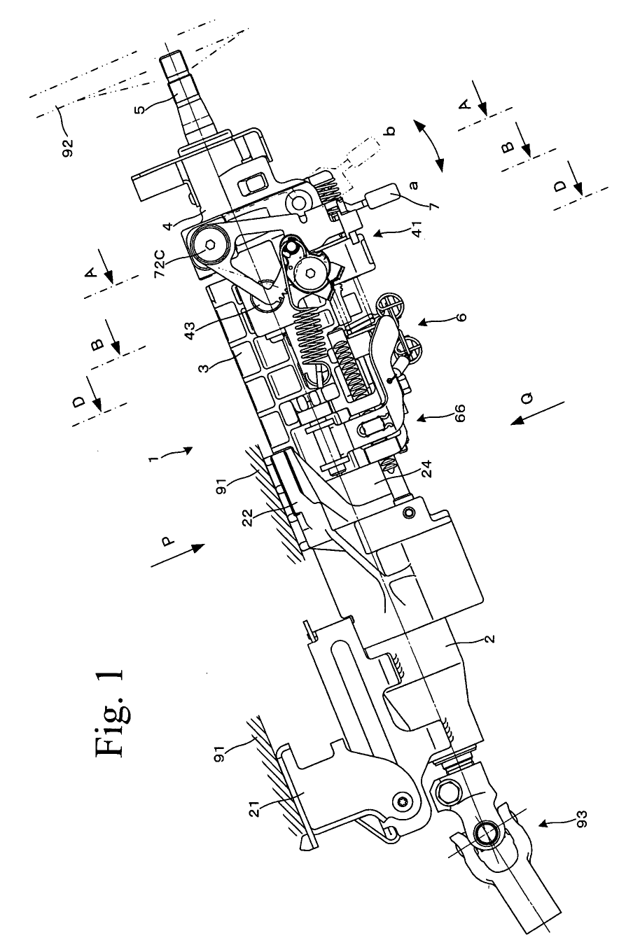

FIGS. 1 to 15 show a steering device according to a first embodiment of the present invention. In the steering device according to the first embodiment, a telescopic mechanism and a tilting mechanism can be clamped or unclamped simultaneously by operating a single control lever in one direction. Furthermore, when the control lever is released, both the telescopic mechanism and the tilting mechanism are held in an unclamped state.

### General Outline

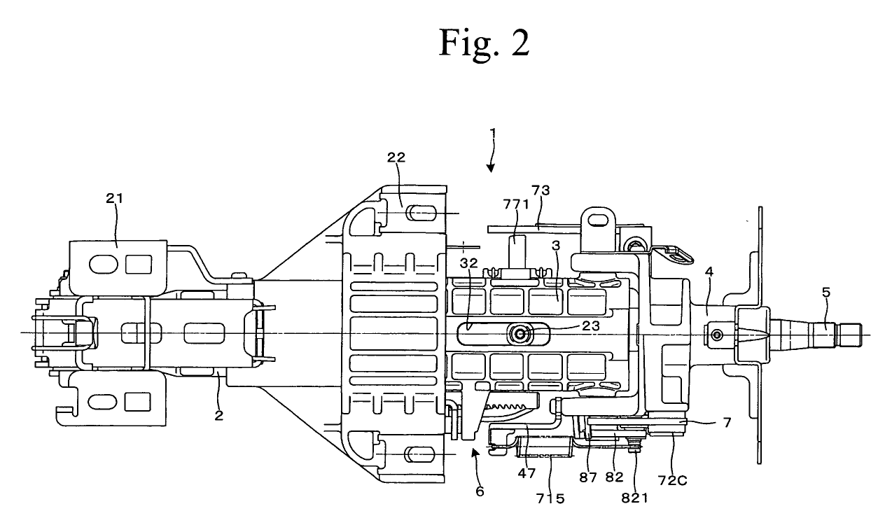

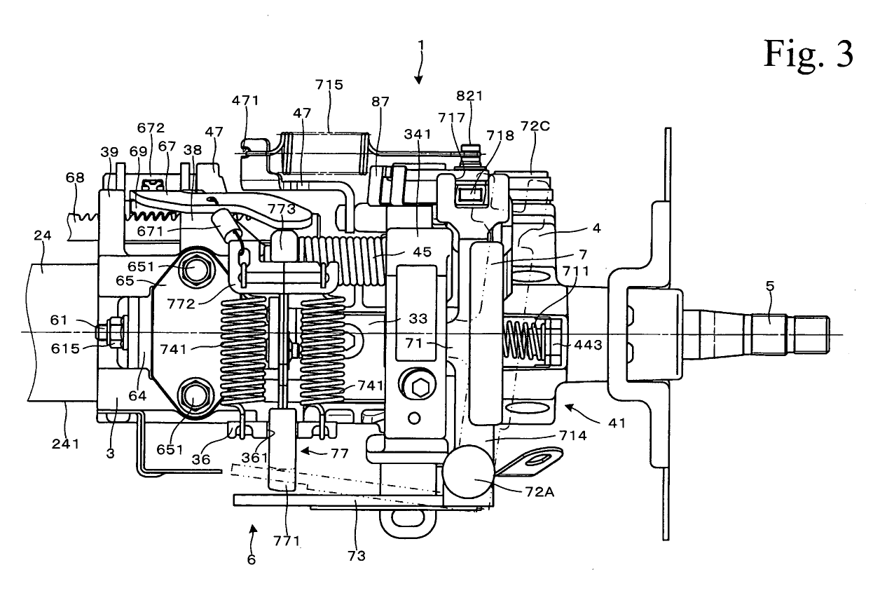

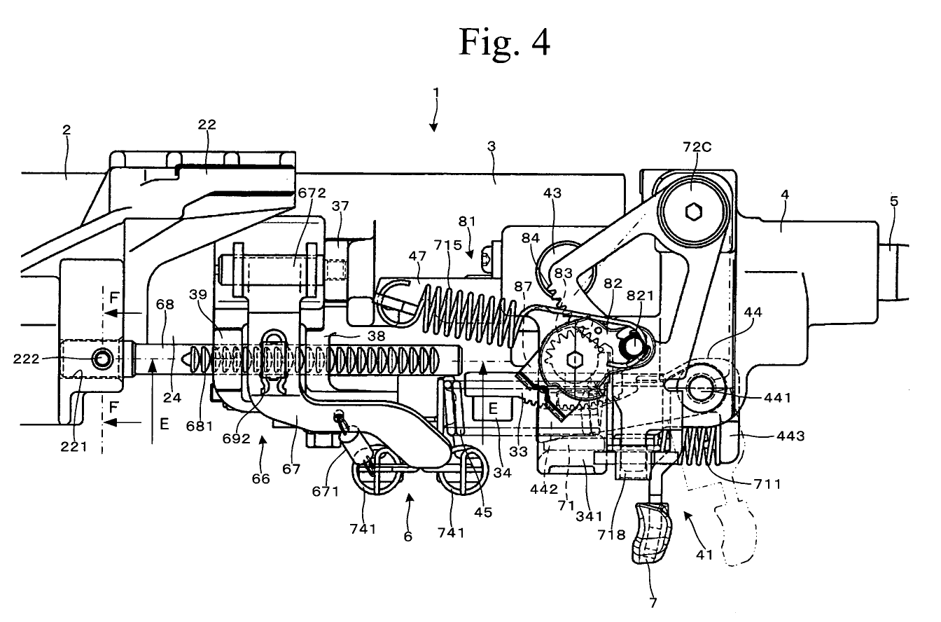

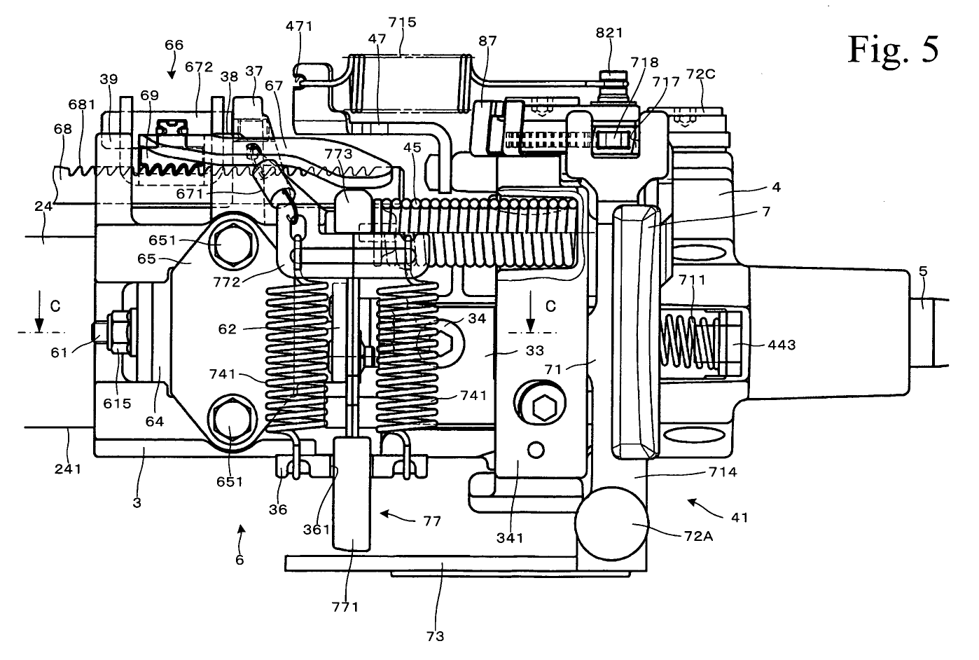

FIG. 1 is an external view of a steering device 1 according to the first embodiment of the present invention. FIG. 2 is a top view showing the steering device 1 as seen in the direction of arrow P in FIG. 1. FIG. 3 is a bottom view of the steering device 1 as seen in the direction of arrow Q in FIG. 1. FIG. 4 is an enlarged side view showing an essential part of the steering device 1. FIG. 5 is an enlarged partly-cross-sectional bottom view corresponding to FIG. 3.

The steering device 1 includes a fixed column member 2, a movable column member 3, a tilt head 4, a steering shaft 5, a column clamp 6, a positive column clamp 66, a tilt head clamp 41, and a control lever 7.

The fixed column member 2 is equipped with a front body attaching part 21 and a rear body attaching part 22 which are used to attach the fixed column member 2 to a vehicle body 91. The movable column member 3 is supported on the fixed column member 2 to be nonrotatable about and telescopically movable in parallel with the center axis of the fixed column member 2. The tilt head 4 is supported on the right end side, as seen in FIG. 1, of the movable column member 3 to be tiltable about a tilt center shaft 43. The steering shaft 5 is rotatably supported by the tilt head 4. A steering wheel 92 is fixed to a right end portion of the steering shaft 5.

The movable column member 3 is equipped with the column clamp 6. The column clamp 6 is provided with a column clamp shaft 61 extending in parallel with the center axis of the movable column member 3. The column clamp 6 is fixed to the movable column member 3 and is movable relative to the fixed column member 2. The movable column member 3 can be clamped to and unclamped from the fixed column member 2 by operating the column clamp 6.

The movable column member 3 is provided with the tilt head clamp 41 that clamps and unclamps the tilt head 4 to and from the movable column member 3. The control lever 7 is supported by the tilt head 4. The control lever 7 is disposed in a position apart from the steering wheel 92. This prevents the driver driving the vehicle from unintentionally touching the control lever while operating the steering wheel 92 and causing the movable column member 3 or the tilt head 4 to be unclamped. The position of the control lever 7 is also intended not to disturb operation of switches disposed around the steering wheel 92.

When the control lever 7 is moved toward the steering wheel 92, a driven lever 714 (FIGS. 3 and 5) is driven to operate the column clamp 6 causing the movable column member 3 to be unclamped. Moving the control lever 7 toward the steering wheel 92 also causes the tilt head 4 to be unclamped.

The left end, as seen in FIG. 1, of the steering shaft 5 is connected to an upper universal joint (not shown) in the steering device 1. The center of the upper universal joint rests on the axis of the tilt center shaft 43, so that the upper universal joint is not affected by tilting of the tilt head 4.

The upper universal joint and a lower universal joint 93 are linked by a spline shaft which includes a male spline shaft and a female spline shaft (neither shown). The movable column member 3 is, therefore, movable in the left-right direction as seen in FIGS. 1 and 2. Thanks to the spline shaft providing spline couplings, when the steering wheel 92 is rotated, the rotation is transmitted, via the lower universal joint 93, to a steering gear to control the front wheel direction regardless of the position of the movable column member 3 and the position in the front-rear direction of the steering wheel 92.

### Tilt Head Clamp

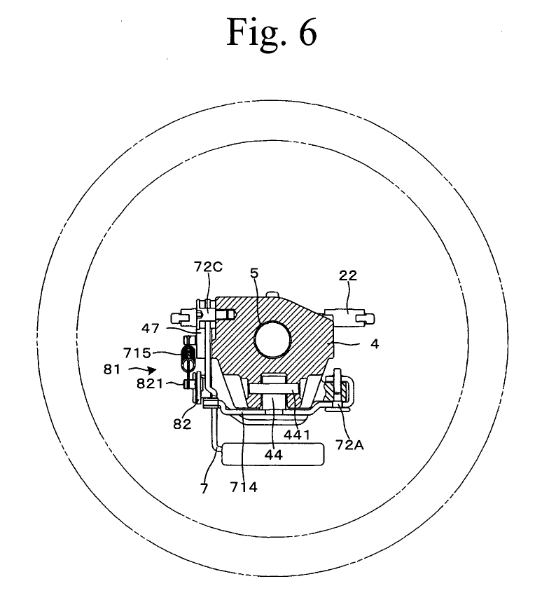

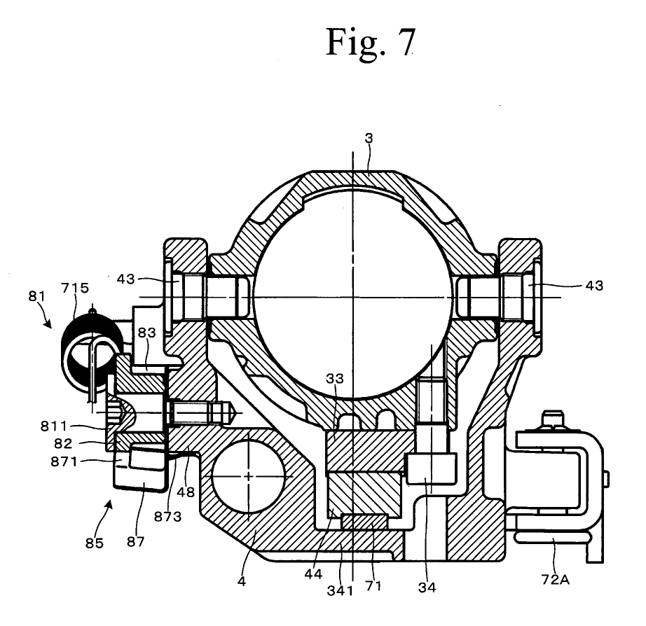

In FIGS. 1, 3, and 4, the control lever 7 in a state before being moved is shown in solid line, and the control lever 7 in a state after being moved toward the steering wheel 92 is shown in two-dot chain line. FIGS. 6 and 7 show cross-sectional views of the steering device 1 taken along lines A-A and B-B in FIG. 1, respectively.

The tilt head clamp 41 is configured as follows. A segment gear 33 having a center at the tilt center shaft 43 is fixed by a bolt 34 to the movable column member 3. The tilt head 4 spaced apart from the segment gear 33 is provided with a backing member 341.

In the space between the tilt head 4 and the segment gear 33, a gear portion 442 formed in a left portion of a gear arm 44 supported by the tilt head 4 to be rotatable about a shaft 441 and a projection 71 are disposed. The tilt head 4 is attached with a driven lever center shaft 72A (FIGS. 3, 5, 6, and 7). A driven lever 714 (FIGS. 3, 5, and 6) which swings about the driven lever center shaft 72A is formed integrally with the projection 71.

The gear arm 44 is L-shaped having two leg-like portions. The gear portion 442 is formed on one of the two leg-like portions. A spring 711 is interposed between the other leg-like portion 443 and the back of the projection 71. The spring 711 applies a biasing force to the other leg-like portion 443 and the projection 71 in the direction for widening the distance between them.

Referring to FIGS. 3 and 4, when the projection 71 is pushed to the left, it pushes the gear portion 442 from behind causing the gear portion 442 to be pressed against the segment gear 33. As a result, the gear portion 442 and the segment gear 33 engage each other. The reaction force that is applied to the projection 71 when the gear portion 442 is pressed against the segment gear 33 is received by the backing member 341. The tilt head 4 is thus fixed to the movable column member 3. The tilt head 4 is fixed in a stepwise position within a tilt angle range where the tilt head 4 and the gear portion 442 can engage each other.

When the projection 71 moves to the right as seen in FIGS. 3 and 4, the pushing force of the spring 711 causes the gear arm 44 to rotate counterclockwise as seen in FIG. 4. As a result, the gear portion 442 and the segment gear 33 disengage from each other causing the tilt head clamp 41 to be released. Therefore, when tilting of the tilt head is adjusted (the telescopic position is also adjustable at the same time), the projection 71 can be moved to the right by moving the control lever 7.

### Fixed Column Member and Movable Column Member

As shown in FIG. 2, an axially elongated opening 32 is formed through the cylindrical wall of the movable column member 3. A stopper 23 with which the fixed column member 2 is provided is engaged in the elongated opening 32. The stopper 23 engaged in the elongated opening 32 prevents the movable column member 3 from coming off the fixed column member 2 and also from rotating relative to the fixed column member 2. Thus, the movable fixed member 3 is axially movable in a range defined by the stopper 23 and the elongated opening 32.

### Column Clamp

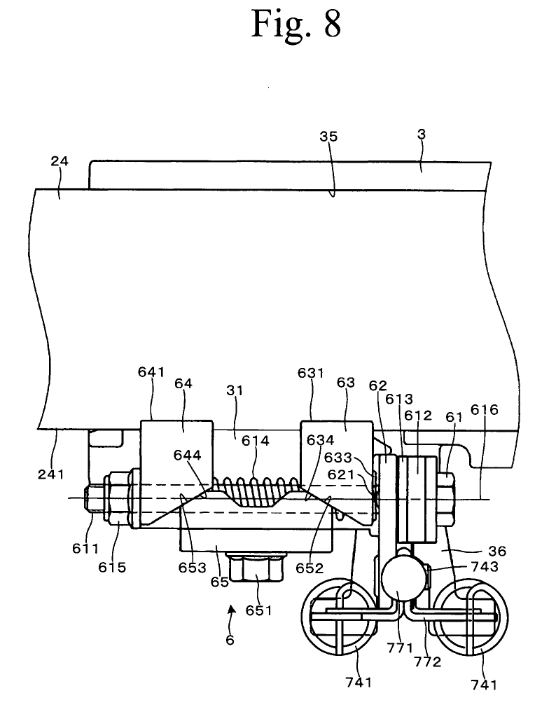

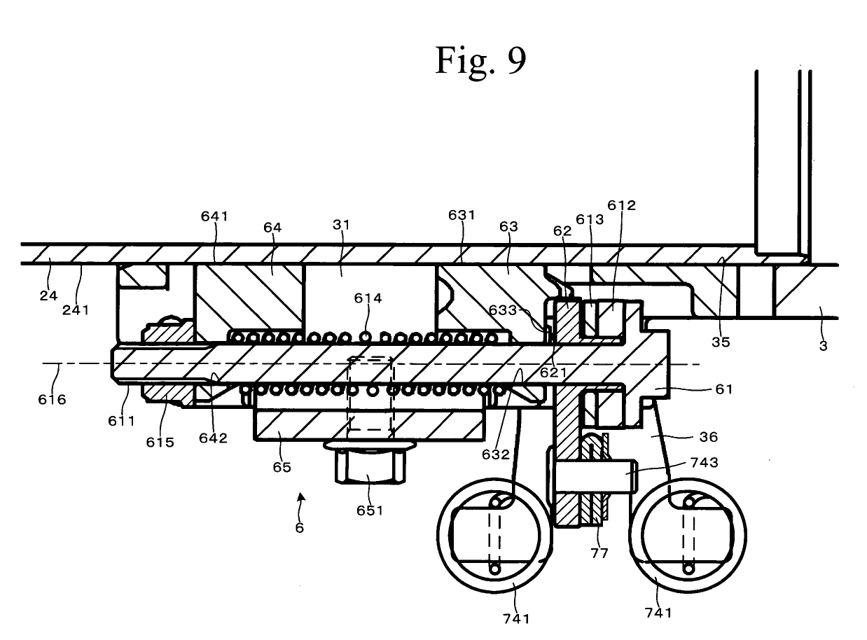

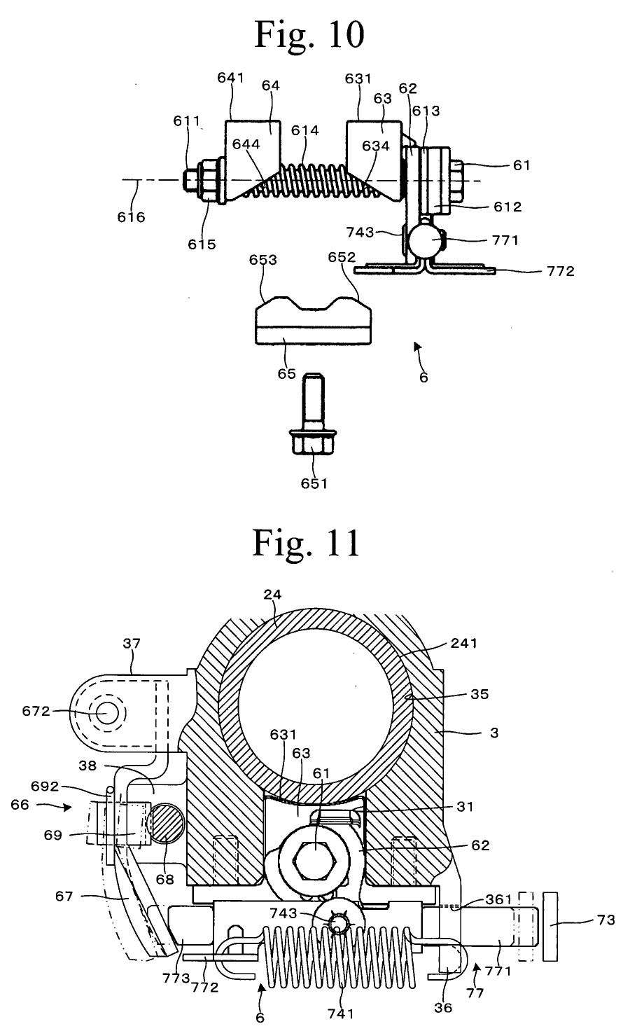

With reference to FIGS. 8 to 11, the configuration of the column clamp 6 will be described. FIG. 8 is a side view showing an essential part of the column clamp 6. FIG. 9 is a cross-sectional view taken along line C-C in FIG. 5 showing the column clamp 6. FIG. 10 is an exploded view of the column clamp 6 in a sub-assembled state. FIG. 11 is a cross-sectional view taken along line D-D in FIG. 1.

The column clamp 6 is provided at the movable column member 3. It includes, from right to left as seen in FIG. 8, a column clamp shaft 61, a thrust bearing 612, a washer 613, a swing arm 62, a first wedge (a first movable wedge) 63, a biasing spring 614, a second wedge (a second movable wedge) 64, and a nut 615.

A wedge hole 31 is formed through an underside of the movable column member 3, as seen in FIG. 8. The wedge hole 31 faces, at its upper end, an outer circumference 241 of a cylindrical guide 24 formed in a portion toward the vehicle rear of the fixed column member 2. The outer circumference 241 of the cylindrical guide 24 is fitted in a guide bore 35 of the movable column member 3 to axially guide the movable column member 3.

The wedge hole 31 is blocked up, at its lower end, by a third wedge (a fixed wedge) 65 which is fixed to the movable column member 3 by two bolts 651. The first and second wedges 63 and 64 are disposed in the wedge hole 31 to be slidable up and down and side to side as seen in FIGS. 8 and 9.

The top faces of the first and second wedges 63 and 64 are substantially arc-shaped to serve as clamp faces 631 and 641, respectively, fitting the outer circumference 241 of the cylindrical guide 24. When clamping the movable column member 3, the clamp faces 631 and 641 facing the outer circumference 241 of the cylindrical guide 24 are brought into contact with the outer circumference 241 of the cylindrical guide 24 to clamp the movable column member 3 to the fixed column member 2.

The first and second wedges 63 and 64 are disposed apart from each other in the axial direction of the movable column member 3. The first and second wedges 63 and 64 have clamp shaft holes 632 and 642, respectively, through which the column clamp shaft 61 is inserted. A nut 615 is screwed onto a male thread 611 formed at a left end portion of the column clamp shaft 61. The nut 615 presses against the second wedge 64.

The biasing spring 614 is fitted over the column clamp shaft 61 between the first and second wedges 63 and 64 and constantly pushes the first and second wedges 63 and 64 thereby biasing them to be away from each other. A cam face 633 is formed around the clamp shaft hole 632 on the right end face of the first wedge 63. The cam face 633 is kept in contact with a cam face 621 formed on the left end face of the swing arm 62, the two cam faces thus make up a cam mechanism. To reduce the frictional resistance between the cam surfaces 633 and 621, rolling contact members such as rollers may be interposed between them.

The third wedge 65 has slopes 652 and 653 outwardly descending as seen in the axial direction of the movable column member 3. The slopes 652 and 653 are in contact with slopes 634 and 644 formed at lower ends of the first and second wedges 63 and 64, respectively.

As shown in FIG. 10, with the third wedge 65 being discrete from the movable column member 3, it is possible to put the column clamp shaft 61, the thrust bearing 612, the washer 613, the swing arm 62, the first wedge 63, the biasing spring 614, the second wedge 64, and the nut 615 together in advance as a subassembly of the column clamp 6 in a subassembly line.

Inserting the subassembly in the wedge hole 31 formed through the underside of the movable column member 3 and clamping the third wedge 65 to the movable column member 3 using the two bolts 651 completes assembly and installation of the column clamp 6. This reduces the time needed to assemble and install the column clamp 6 in a main assembly line, while allowing the subassembly to be prepared with ease in a spacious location.

When the swing arm 62 is swung (clockwise as seen in FIG. 11) to unclamp the movable column member 3 shown in a clamped state in FIGS. 8, 9, and 11, the cam face 621 of the swing arm 62 moves to position its elevated portion against a depressed portion of the cam face 633 of the first wedge 63.

This causes the first and second wedges 63 and 64 to be pushed more away from each other by the biasing spring 614. As a result, the first and second wedges 63 and 64 come down causing the clamp faces 631 and 641 to come off the outer circumference 241 of the cylindrical guide 24, that is, causing the movable column member 3 to be unclamped. Thus, the movable column member 3 can be forcedly unclamped without fail using the pushing force of the biasing spring 614.

When the swing arm 62 is swung in the opposite direction (counterclockwise as seen in FIG. 11), the cam face 621 moves to position its elevated portion against an elevated portion of the cam face 633 of the first wedge 63. This causes the column clamp shaft 61 to be pulled rightward, as seen in FIGS. 8 and 9, causing the second wedge 64 to be pushed also rightward by the nut 615. As a result, the first wedge 63 is pushed leftward by the swing arm 62 to bring the two wedges closer to each other.

This causes the slopes 634 and 644 of the first and second wedges 63 and 64 to move along the slopes 652 and 653, respectively, of the third wedge 65 thereby moving the first and second wedges 63 and 64 up to press their clamp faces 631 and 641 against the outer circumference of the cylindrical guide 24. The movable column member 3 is thus clamped to the fixed column member 2.

### Control Lever Operation

In the following, operation of the control lever 7 and parts interlocked with the control lever 7 will be described. As shown in FIGS. 2 to 7, the control lever 7 is swingably attached to the left side of the tilt head 4. The driven lever 714 that swings being driven by the control lever 7, a pusher plate 73 extending leftward (toward the vehicle front) integrally from the driven lever 714, and the projection 71 formed integrally with the driven lever 714 are seen under the tilt head 4. The driven lever 714 and the pusher plate 73 are, as a whole, laterally-inverted L-shaped.

Also, a bias direction reversing mechanism 81 and a swing lever retention mechanism 85 are seen at a side of the tilt head 4. In FIG. 3, the control lever 7 in a state where it has been moved to adjust the position in the front-rear direction and the tilt angle of the tilt head 4 (with the swingable end of the control lever 7 moved toward the steering wheel 92) is shown in two-dot chain line, and the control lever 7 in a state where it has been moved back away from the steering wheel 92 and restored in its initial position is shown in solid line.

FIG. 1 also shows the control lever 7 in a state where it has been moved (moved into an end position b for unclamping) and in a state where it has been restored (moved back into an end position a for clamping) in two-dot chain line and solid line, respectively.

The control lever 7 is swingably supported by a lever center shaft 72C screwed in a side of the tilt head 4. The bias direction reversing mechanism 81 is mounted on a center shaft 811 (FIG. 7) screwed in a side of the tilt head 4. The bias direction reversing mechanism 81 includes a swing lever 82, an engagement pin 821, a pinion 83, and a segment gear 84.

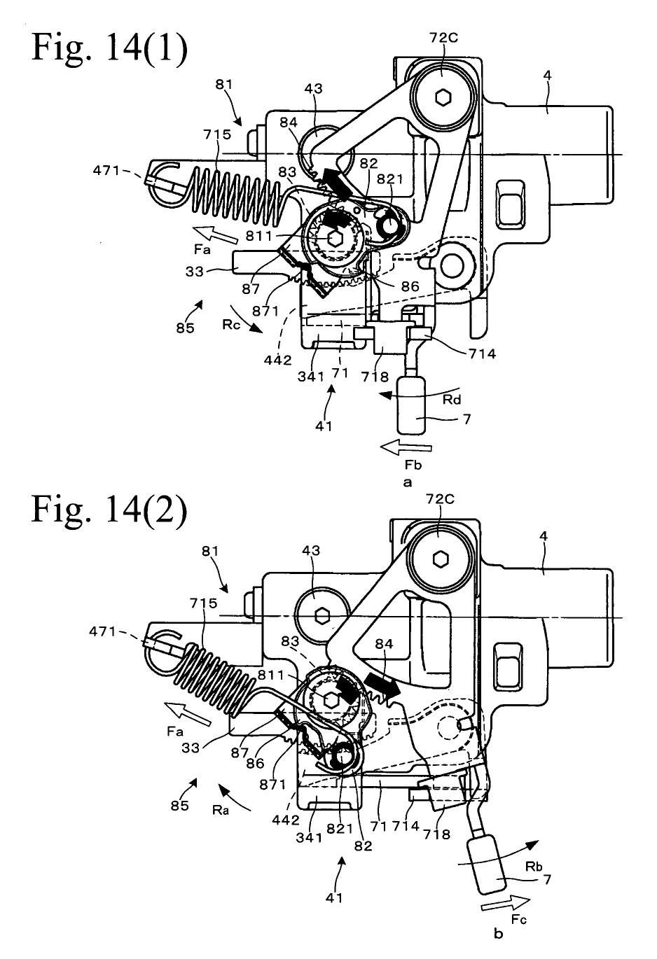

The swing lever 82 is formed of sintered material. It is swingably supported by the center shaft 811 screwed in the side of the tilt head 4. A pinion 83 is formed in a boss portion of the swing lever 82. The pinion 83 engages the segment gear 84 (FIGS. 4, 14(1), and 14 (2)) formed on the control lever 7.

A biasing spring (biasing member) 715 is stretched between the engagement pin 821 attached to the swing lever 82 and an engagement recess 471 formed on a bracket 47 attached to a left end portion of the tilt head 4. When the control lever 7 is positioned near the end position a for clamping, the biasing spring 715 biases the control lever 7 in the clockwise direction via the swing lever 82, pinion 83, and segment gear 84.

A fork-shaped engagement recess 717 (FIGS. 3 and 5) is formed on the driven lever 714. An engagement projection 718 at an end portion of the control lever 7 is fitted in the engagement recess 717. Therefore, when the control lever 7 is moved, the driven lever 714 is driven to swing about the driven lever center shaft 72A.

Before the control lever 7 is moved, it is positioned as shown in solid line in FIG. 3 (in the end position a for clamping). Namely, the control lever 7 biased by the biasing spring 715 is held in a position for starting a clockwise swing. In this state, the projection 71 of the driven lever 714 is pushed leftward keeping the tilt head 4 clamped.

When the control lever 7 is moved toward the steering wheel 92 to adjust the tilting position and telescopic position of the tilt head 4, the driven lever 714 swings clockwise about the driven lever center shaft 72A. Moving the control lever 7 to the position (the end position b for unclamping) shown in two-dot chain line in FIG. 3 moves the projection 71 integrated with the driven lever 714 rightward thereby releasing the tilt head clamp 41.

When the control lever 7 is moved from the position (the end position a for clamping) shown in solid line in FIG. 3 to the position (the end position b for unclamping) shown in two-dot chain line in FIG. 3, the pressure plate 73 integrated with the driven lever 714 pushes a right head portion 771 at a right end of a pusher rod 77 in to release the column clamp 6. Thus, the tilt head clamp 41 and the column clamp 6 can be released at a time by pulling the control lever 7 once.

The pusher rod 77 (FIGS. 9 and 11) is pivotally supported, at an approximately midpoint of its length in the lateral direction as seen in FIG. 11, by a lower end portion of the swing arm 62 and a pin 743. Referring to FIGS. 5 and 11, the movable column member 3 has a downwardly projecting rib 36 on which a rectangular guide groove 361 is formed. The right head portion 771 at the right end of the pusher rod 77 is fitted in the rectangular groove 361, so that the pusher rod 77 is movable laterally, as seen in FIG. 11, being guided by the guide groove 361.

As shown in FIGS. 5 and 11, two biasing springs 741 are stretched between the rib 36 and a flange 772 of the pusher rod 77, pushing the pusher rod 77 rightward as seen in FIG. 11. The swing arm 62 linked with the pusher rod 77 by the pin 743 is therefore biased for a clockwise rotation. The force biasing the swing arm 62 for a swing keeps the swing arm 62 in a clamping position shown in solid line (FIG. 11).

### Positive Column Clamp

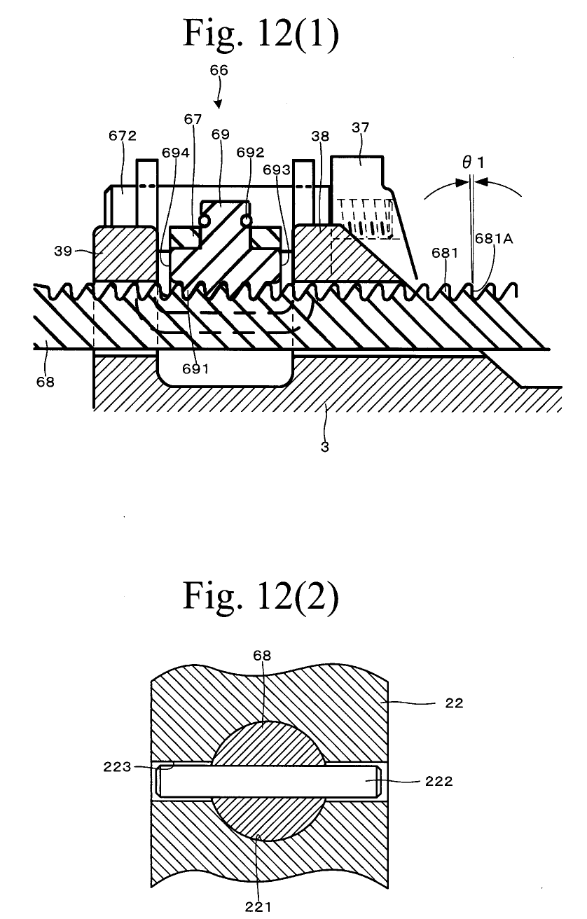

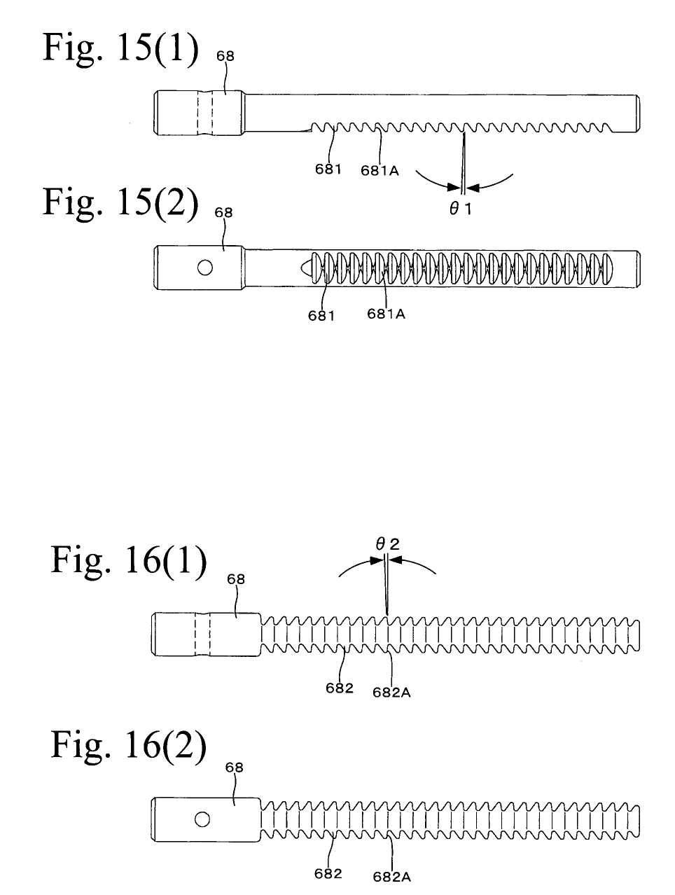

The configuration of the positive column clamp 66 will be described with reference to FIGS. 3 to 5, 11, 12, and 15. FIG. 12(1) is a cross-sectional view taken along line E-E in FIG. 4. FIG. 12(2) is a cross-sectional view taken along line F-F in FIG. 4. FIGS. 15(1) and (2) are part drawings showing a first toothed member alone used in the first embodiment, FIG. 15(1) being a front view of the toothed member and FIG. 15(2) being a bottom view corresponding to FIG. 15(1).

The positive column clamp 66 includes a swing lever 67, a biasing spring 671, a swing center shaft 672, a first toothed member 68, and a second toothed member 69. It is disposed between the movable column member 3 and the fixed column member 2.

The first toothed member 68 that is like a round bar is, with its left end portion inserted in a cylindrical hole 221 (FIGS. 4 and 12 (2)) formed in a side of the body attaching part 22 of the fixed column member 2, fixed to the body attaching part 22 by a pin 222. The first toothed member 68 extends long toward the vehicle rear in parallel with the center axis of the fixed column member 2. Plural engagement teeth 681 shaped like saw teeth are formed at a constant pitch approximately over the whole length of the first toothed member 68. As shown in FIGS. 15(1) and (2), the engagement teeth 681 of the first toothed member 68 used in the first embodiment are formed on a side portion of the outer circumferential surface of the first toothed member 68 shaped like a round bar. The engagement teeth 681 have faces which face outwardly in the vehicle width direction with the teeth traces aligned in the vehicle body vertical direction.

The swing center shaft 672 shaped like a round bar is fixedly screwed in a boss 37 projectingly formed on a side of the movable column member 3. The swing center shaft 672 extends toward the vehicle front in parallel with the first toothed member 68. The swing lever 67 is supported by the swing center shaft 672 to be swingable about the swing center shaft 672 and slidable along the center axis of the swing center shaft 672.

The second toothed member 69 is fixed to the swing lever 67 by a clip 692. The second toothed member 69 has plural engagement teeth 691 shaped like saw teeth and facing the engagement teeth 681 of the first toothed member 68. The engagement teeth 691 are formed with the same pitch as that of the engagement teeth 681.

A biasing spring 671 is stretched between the flange 772 of the pusher rod 77 and the swing lever 67. The swing lever 67 is biased by the biasing spring 671 toward a left head portion 773 at the left end of the pusher rod 77 (in the counterclockwise direction as seen in FIG. 11), and the engagement teeth 691 of the second toothed member 69 are engaged with the engagement teeth 681 of the first toothed member 68.

The pin 222 that fixes the first toothed member 68 in the cylindrical hole 221 formed in the body attaching part 22 has an outer diameter such that a small clearance is formed between the outer circumference of the pin 222 and the inner circumference of the cylindrical hole 221 as shown in FIG. 12(2). The first toothed member 68 is therefore rotatable about the center axis of the cylindrical hole 221 within a range defined by the clearance.

Therefore, if an error such as a machining error or an assembly error with respect to the center axis of the cylindrical hole 221 is present between the engagement teeth 691 of the second toothed member 69 and the engagement teeth 681 of the first toothed member 68, the error is made up for as the first toothed member 68 rotates about the axis of the cylindrical hole 221, thereby, allowing the engagement teeth 691 to smoothly engage the engagement teeth 681. This makes it easy to manufacture and assemble the first and second toothed members 68 and 69 and other parts making up the positive column clamp 66.

The cylindrical hole 221 has an inner diameter slightly larger than the outer diameter of the first toothed member 68, so that a small clearance is formed between the inner circumference of the cylindrical hole 221 and the outer circumference of the first toothed member 68. When the column clamp 6 makes clamping or unclamping, the clamp faces 631 and 641 of the first and second wedges 63 and 64, respectively, are pressed against or withdrawn from the outer circumference 241 of the cylindrical guide 24 of the fixed column member 2. At such times, the movable column member 3 slightly moves relative to the fixed column member 2 in the vertical direction of the vehicle body (in the direction of pressing by the column clamp 6).

When the column clamp 6 makes clamping or unclamping, the first toothed member 68 slightly moves up and down in the vertical direction of the vehicle body (in the direction of pressing by the column clamp 6) with the pin 222 at the center of the up-and-down movement or moves in a direction perpendicular to the axis of the first toothed member 68. This allows, even if the movable column member 3 slightly moves relative to the fixed column member 2 in the vertical direction of the vehicle body, the engagement teeth 691 of the second toothed member 69 to smoothly engage the engagement teeth 681 of the first toothed member 68.

As shown in FIG. 12(1), there is some clearance between a rib 38 and the end 693 toward the vehicle rear of the second toothed member 69 and also between a rib 39 and the end 694 toward the vehicle front of the second toothed member 69. The clearance is at least as large as the pitch with which the engagement teeth 681 and 691 are formed. Namely, when the engagement teeth 691 and 681 engage each other, the swing lever 67 slides along the swing center shaft 672 and the second toothed member 69 slightly moves in the axial direction of the first toothed member 68. This enables engagement between the second toothed member 69 and the first toothed member 68 regardless of the telescopic position clamped by the column clamp 6 using wedges.

When the driver hits the steering wheel 92 at a time of a secondary collision, the movable column member 3 is subjected to an impact force in the direction toward the vehicle front. When the impact force exceeds the clamping force of the column clamp 6 using wedges, the clamp faces 631 and 641 of the first and second wedges 63 and 64, respectively, slide along the outer circumference 241 of the cylindrical guide 24, causing the movable column member 3 to slightly move toward the vehicle front.

With the engagement teeth 691 of the second toothed member 69 engaging the engagement teeth 681 of the first toothed member 68, however, the reaction force applied from the first toothed member 68 to the second toothed member 69 slightly moves the second toothed member 69 toward the vehicle rear (to the right as seen in FIG. 12(1)) (as seen from the vehicle body side, the movable column member 3 moves to the left as seen in FIG. 12(1) relative to the second toothed member 69). When the end 693 toward the vehicle rear of the second toothed member 69 comes into contact with the rib 38 on a side of the movable column member 3, the second toothed member 69 can no longer move toward the vehicle rear (that is, as seen from the vehicle body side, the movable column member 3 can no longer move to the left as seen in FIG. 12(1) relative to the second toothed member 69), so that the movable column member 3 is prevented from moving toward the vehicle front.

The friction factor between the engagement teeth 691 of the second toothed member 69 and the engagement teeth 681 of the first toothed member 68 ranges from 0.12 to 0.15. An angle θ1 between a tooth face 681A facing the vehicle rear of each of the engagement teeth 681 (the tooth face subjected to an impact force when a secondary collision occurs) and a line perpendicular to the center axis of the first toothed member 68 as shown in FIG. 12(1) is set to be in a range of 0 to 6 degrees.

Namely, the angle θ1 of the tooth face 681A that is subjected to the impact force of a secondary collision is set to be smaller than the friction angle between the engagement teeth 691 and 681. Therefore, providing the biasing spring 671 with a biasing force which is large enough to prevent the engagement teeth 691 of the second toothed member 69 and the engagement teeth 681 of the first toothed member 68 from being disengaged on account of vibrations, etc. can prevent the engagement teeth 691 of the second toothed member 69 from sliding on the engagement teeth 681 of the first toothed member 68 even when subjected to a large impact force of a secondary collision. This reduces the force required by the positive column clamp 66 when unclamping.

Therefore, even if, at a time of a secondary collision, a large impact force is applied to the movable column member 3 in the direction toward the vehicle front causing the column clamp 6 that uses a friction force for clamping to slide, the second toothed member 69 does not slide relative to the first toothed member 68. Thus, the movable column member 3 does not collide with the body attaching part 22, so that the driver can be prevented from being subjected to a large impact force.

Referring to FIG. 3, when the control lever 7 is moved from the position shown in solid line (the end position a for clamping) to the position shown in two-dot chain line (the end position b for unclamping) to release the tilt head clamp 41 and the column clamp 6, the pusher plate 73 integrated with the driven lever 714 pushes the right head portion 771 at the right end of the pusher rod 77 in, causing the left head portion 773 at the left end of the pusher rod 77 to swing the swing lever 67 (clockwise as seen in FIG. 11).

As a result, the engagement teeth 691 of the second toothed member 69 and the engagement teeth 681 of the first toothed member 68 disengage from each other. This allows the driver to release the control lever 7 and adjust, holding the steering wheel 92 with both hands, the position in the front-rear direction and the tilt angle of the steering wheel 92 (the operation of the swing lever retention mechanism 85 will be described later).

When the driver finishes adjusting the position in the front-rear direction and the tilt angle of the steering wheel 92, the driver releases the steering wheel 92 and moves the control lever 7 back with the released hand, causing the driven lever 714 to swing counterclockwise about the driven lever center shaft 72A. As a result, the tilt head 4 is clamped to the movable column member 3. At the same time, the pusher plate 73 swings to the position shown in solid line in FIG. 3, causing the pusher rod 77 biased by the biasing springs 741 to move rightward, as seen in FIG. 11, to the position shown in solid line.

The rightward move of the pusher rod 77 causes the swing arm 62 to swing counterclockwise and the first and second wedges 63 and 64 of the column clamp 6 to come closer to each other. As a result, the movable column member 3 is clamped.

When the pusher rod 77 moves to the right, the biasing force of the biasing spring 671 causes the swing lever 67 to start swinging counterclockwise, and the engagement teeth 691 of the second toothed member 69 attached to the swing lever 67 start engaging the engagement teeth 681 of the first toothed member 68.

Since the column clamp 6 makes clamping by friction using wedges, the clamped position of the movable column member 3 can be adjusted steplessly. The positive column clamp 66 that includes the second toothed member 69 and the first toothed member 68 makes clamping in steps defined by the pitch of the engagement teeth 681 and 691. This may cause the engagement between the engagement teeth 691 of the second toothed member 69 and the engagement teeth 681 of the first toothed member 68 to be displaced.

The swing lever 67 attached to the second toothed member 69, however, slides, being guided by the swing center shaft 672, a distance equal to the engagement displacement along the center axis of the first toothed member 68. The maximum distance that the swing lever 67 can slide along the center axis of the first toothed member 68 is defined by the clearance between the rib 38 on a side of the movable column member 3 and the end 693 toward the vehicle rear of the second toothed member 69 and the clearance between the rib 39 on the side of the movable column member 3 and the end 694 toward the vehicle front of the second toothed member 69. The engagement teeth 691 of the second toothed member 69 are thus enabled to correctly engage the engagement teeth 681 of the first toothed member 68.

Even though the positive column clamp 66 is formed at sides of the fixed column member 2 and movable column member 3, its position is not limited to the sides. The positive column clamp 66 may be disposed at an optional location, for example, above or below the fixed column member 2 and movable column member 3.

### Second Embodiment

A second embodiment of the present invention will be described next. FIGS. 16(1) and (2) are part drawings showing a first toothed member alone used in the second embodiment, FIG. 16(1) being a front view of the toothed member and FIG. 16(2) being a bottom view corresponding to FIG. 16(1). The following description of the second embodiment will cover only parts and operations differing from those of the first embodiment to avoid duplicate description. The same parts as those used in the first embodiment will be denoted by the same reference numerals as used in the first embodiment.

As shown in FIGS. 16(1) and 16(2), a first toothed member 68 used in the second embodiment has engagement teeth 682 formed around its whole outer circumference, the first toothed member 68 being shaped like a round bar. An angle θ2 formed between a tooth face 682A facing the vehicle rear of each of the engagement teeth 682 (the tooth face subjected to an impact force when a secondary collision occurs) and a line perpendicular to the center axis of the first toothed member 68 is set to be in a range of 0 to 6 degrees as in the first embodiment.

With the engagement teeth 682 formed around the whole circumference of the first toothed member 68, if the engagement teeth 691 of the second toothed member 69 includes an error such as a machining error or an assembly error with respect to the center axis of the cylindrical hole 221, the engagement teeth 691 can smoothly engage the engagement teeth 682. This makes it easy to manufacture and assemble the second toothed members 69.

### Bias Direction Reversing Mechanism

The configuration and operation of the bias direction reversing mechanism 81 will be described below with reference to FIGS. 14(1) and 14(2). FIG. 14(1) is an operation diagram showing the bias direction reversing mechanism 81 with the control lever 7 in the end position a for clamping shown in solid line in FIGS. 1 and 3 (the state before the control lever 7 is moved). FIG. 14(2) is an operation diagram showing the bias direction reversing mechanism 81 with the control lever 7 in the end position b for unclamping shown in two-dot line in FIGS. 1 and 3 (the state after the control lever 7 is moved).

Referring to FIG. 14(1), when the control lever 7 is in the end position a for clamping, the swing lever 82 is biased toward a swing end in the counterclockwise direction about the center shaft 811 (the direction of the filled arrow Rc) by a biasing force Fa of the biasing spring 715 via the engagement pin 821. In this state, the segment gear 84 engaging the pinion 83 is biased in the clockwise direction, so that the control lever 7 is biased toward a swing end in the clockwise direction (the direction of the filled arrow Rd) by a biasing force (denoted by the hollow arrow Fb).

At this time, the projection 71 of the driven lever 714 is pushed to the left, and the tilt head clamp 41 is in a clamping state. The pressure plate 73 integrated with the driven lever 714 is in the position shown in solid line in FIG. 3, so that the column clamp 6 is also in a clamping state.

When the control lever 7 is moved toward the steering wheel 92, the control lever 7 swings, as shown in FIG. 14(2), counterclockwise (in the direction of the filled arrow Rb) about the lever center shaft 72C. As a result, the segment gear 84 rotates the pinion 83 clockwise (in the direction of the filled arrow Ra), so that the swing lever 82 integrated with the pinion 83 also swings clockwise (in the direction of the filled arrow Ra).

In FIGS. 14(1) and 14(2), the filled arrows Ra and Rc respectively denote the swing directions of the swing lever 82, the filled arrows Rb and Rd the swing directions of the control lever 7, the hollow arrows Fa, Fb, and Fc the directions in which the swing lever 82 and the control lever 7 are biased by the biasing spring 715.

When the swing lever 82 swings clockwise (in the direction of the filled arrow Ra), the center of the engagement pin 821 comes closer to a linear line passing the engagement recess 471 and the center shaft 811. This causes the vertical distance between the center of the center shaft 811 and the vector of the biasing force (denoted by the hollow arrow Fa) of the biasing spring 715 acting on the engagement pin 821 to gradually approach zero. Hence, the moment of force of the biasing spring 715 applied to the engagement pin 821 to swing the swing lever 82 counterclockwise gradually approaches zero.

Therefore, as the centers of the engagement recess 471, center shaft 811, and engagement pin 821 come closer to their respective positions where they are aligned on a straight line, the clockwise biasing force (denoted by the hollow arrow Fb) applied by the biasing spring 715 to the control lever 7 gradually approaches zero. As a result, the force required to move the control lever 7 toward the steering wheel 92 resisting the biasing force of the biasing spring 715 gradually approaches zero. At this time, the driven lever 714 driven by the control lever 7 swings clockwise about the driven lever center shaft 72A. This causes the projection 71 integrated with the driven lever 714 to move to the right and unclamping by the tilt head clamp 41 to progress.

At the same time, the pusher plate 73 integrated with the driven lever 714 pushes the right head portion 771 of the pusher rod 77 in opposing the biasing forces of the biasing springs 741, so that unclamping operations of the column clamp 6 and positive column clamp 66 progress. Therefore, the force required to move the control lever 7 toward the steering wheel 92 gradually increases by addition of the force required to push in the pusher rod 77 opposing the biasing forces of the biasing springs 741.

As the control lever 7 is moved closer to the steering wheel 92, the centers of the engagement recess 471, center shaft 811, and engagement pin 821 are aligned on a straight line, causing the moment of force of the biasing spring 715 for swinging the swing lever 82 counterclockwise to become zero. When the control lever 7 is moved still closer to the steering wheel 92, the swing lever 82 further swings clockwise (in the direction of the filled arrow Ra), causing the engagement pin 821 to come away from the straight line passing the centers of the engagement recess 471 and center shaft 811.

At this time, as shown in FIG. 14(2), the swing lever 82 is biased for a clockwise swing about the center shaft 811 by the biasing spring 715 via the engagement pin 821, and the segment gear 84 engaging the pinion 83 is biased counterclockwise, so that the control lever 7 is biased in the counterclockwise direction (denoted by the hollow arrow Fc). Namely, the direction in which the control lever 7 is biased by the biasing spring 715 is reversed when the state where the centers of the engagement recess 471, center shaft 811, and engagement pin 821 are aligned on a straight line is passed.

As the swing lever 82 swings clockwise (in the direction of the filled arrow Ra) and the centers of the engagement recess 471, center shaft 811, and engagement pin 821 come more away from their respective positions aligned on a straight line, the vertical distance between the center of the center shaft 811 and the vector of the biasing force (denoted by the hollow arrow Fa) of the biasing spring 715 acting on the engagement pin 821 gradually increases. Hence, the moment of force of the biasing spring 715 applied to the engagement pin 821 to swing the swing lever 82 clockwise (in the direction of the filled arrow Ra) gradually increases.

Therefore, the counterclockwise biasing force (denoted by the hollow arrow Fc) applied by the biasing spring 715 to the control lever 7 gradually increases. As a result, the force required for the pusher plate 73 to push in the pusher rod 77 opposing the biasing forces of the biasing springs 741 gradually decreases, so that the force required to move the control lever 7 toward the steering wheel 92 gradually decreases.

When the control lever 7 reaches the end position b for unclamping, shown in FIG. 14(2), the projection 71 integrated with the driven lever 714 reaches a right end position and the tilt head clamp 41 completes unclamping. At the same time, the pressure plate 73 integrated with the driven lever 714 pushes the right head portion 771 of the pusher rod 77 in and the column clamp 6 and positive column clamp 66 also complete unclamping.

In this state, even when the control lever 7 is released, the control lever 7 is held in the end position b for unclamping, shown in FIG. 14(2), and the tilt head clamp 41, column clamp 6, and positive column clamp 66 remain in a released state (the operation of the swing lever retention mechanism 85 will be described later). This allows the driver to adjust, holding the steering wheel 92 with both hands, the tilt angle and the position in the front-rear direction of the steering wheel 92 with ease.

When the driver finishes adjusting the tilt angle and the position in the front-rear direction of the steering wheel 92, the driver releases one hand from the steering wheel 92 and moves, with the released hand, the control lever 7 in the direction away from the steering wheel 92. This causes the tilt head clamp 41, column clamp 6, and positive column clamp 66 to carry out clamping in reverse of the above order, thereby restoring the state shown in FIG. 14(1).

Since the control lever 7 is biased in the clockwise direction by the biasing spring 715, it remains in the end position a for clamping, shown in FIG. 14(1), even after the driver releases the control lever 7.

### Swing Lever Retention Mechanism

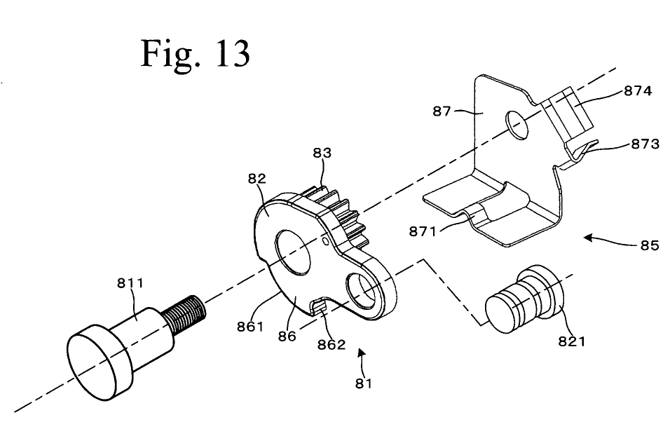

The configuration and operation of the swing lever retention mechanism 85 will be described with reference to FIGS. 7, 13, 14(1), and 14(2). FIG. 13 is an exploded perspective view showing the swing lever and a swing lever retention spring. The counterclockwise biasing force (denoted by the hollow arrow Fc) applied to the. control lever 7 by the biasing force (denoted by the hollow arrow Fa) of the biasing spring 715 is preferably approximately equivalent to or slightly larger than the force required to push in the pusher rod 77 opposing the biasing forces of the biasing springs 741 for the column clamp 6 and positive column clamp 66.

This is because when the biasing force of the biasing spring 715 is increased, the force required to move the control lever 7 out of the end position b for unclamping into the end position a for clamping correspondingly increases. Furthermore, the force required to move the control lever out of the end position a for clamping into the end position b for unclamping (that is, to move the control lever until the center axis of the biasing spring 715 passes the center shaft 811) also increases.

It is to avoid the above problems that the biasing force of the biasing spring 715 is set to be approximately equivalent to or slightly larger than the force required to push the pusher rod 77 in. In this arrangement, however, the control lever 7 can move easily when in the end position b for unclamping, so that, when the position in the front-rear direction or the tilt angle of the steering wheel 92 is adjusted, inertia generated during the adjustment work, i.e. impacts and vibrations, may cause the control lever 7 to be displaced.

To eliminate the problem as described above, the swing lever retention mechanism 85 provided for the tilt head 4 serves to retain the control lever 7 in the end position b for unclamping. As shown in FIGS. 7, 13, 14(1), and 14(2), the swing lever retention mechanism 85 includes an engagement projection 86 formed on the outer circumference of the swing lever 82 and a swing lever retention spring 87 having an engagement projection 871.

The swing lever retention spring 87 is attached, together with the swing lever 82, to a side of the tilt head 4 by the center shaft 811 screwed in the tilt head 4. Engagement projections 873 and 874 formed by the swing lever retention spring 87 are in tight contact with the outer circumference of a boss portion 48 on the side of the tilt head 4, so that swinging of the swing lever 82 does not cause the swing lever retention spring 87 to swing. Thus, the swing lever retention spring 87 is fixedly attached to the side of the tilt head 4.

The engagement projection 871 of the swing lever retention spring 87 is formed with a ridge-like top oriented toward the center of the swing lever 82. The engagement projection 86 formed on the outer circumference of the swing lever 82 is shaped like a saw tooth having a gentle slope and a steep slope. The gentle slope is shaped substantially like a circular arc whose diameter is larger where it is closer to the steep slope. The steep slope 862 stretches from the top of the gentle slope toward the center of the swing lever 82 (i.e. a plane stretching approximately toward the center of the swing lever 82). When the swing lever retention mechanism 85 is assembled, the top of the gentle slope 861 is positioned more away, in a radial direction, from the center of the swing lever 82 than the ridge-like top of the swing lever retention spring 87.

When the control lever 7 is moved out of the end position a for clamping shown in FIG. 14(1), toward the end position b for unclamping shown in FIG. 14(2), the swing lever 82 swings clockwise (in the direction denoted by the filled arrow Ra) with the gentle slope 861 of the engagement projection 86 causing the engagement projection 871 of the swing lever retention spring 87 to undergo outward elastic deformation in a radial direction.

When the control lever 7 reaches the end position b for unclamping shown in FIG. 14(2), the top of the gentle slope 861 passes the ridge-like top of the engagement projection 871 of the swing lever retention lever 82 causing the steep slope 862 and the ridge-like top of the engagement projection 871 to engage each other. In this state, the swing lever 82 is prevented from swinging counterclockwise, so that the control lever 7 is held in the end position b for unclamping. Hence, impacts generated during positional adjustment of the steering wheel 92 cannot cause the control lever 7 to be displaced out of the end position b for unclamping toward the end position a for clamping.

According to the second embodiment, the gentle slope 861 is formed on the engagement projection 86. When the control lever 7 is moved toward the end position b for unclamping thereby causing the swing lever 82 to swing, the gentle slope 861 causes the engagement 871 of the swing lever retention spring 87 to gradually undergo outward elastic deformation in a radial direction. This causes the driver operating the control lever 7 to obtain a good operational feeling.

The swing lever 82 is formed of sintered material, so that it is smooth-surfaced resulting in a small friction factor between its engagement projection 86 and the engagement projection 871 of the swing lever retention spring 87. This allows the driver operating the control lever 7 to obtain a good operational feeling. Moreover, the wear of the swing lever 82 and swing lever retention spring 87 is reduced, and their durability improves.

### Steering Wheel Adjustment

The operations for adjusting the position in the front-rear direction and the tilt angle of the steering wheel 92 and the movements of associated parts will be described below.

When adjusting the position in the front-rear direction and the tilt angle of the steering wheel 92, the driver releases one hand from the steering wheel 92 and moves, with the released hand, the control lever 7 out of the end position a for clamping toward the end position b for unclamping (in the direction denoted by the filled arrow Rb). In this operation, the control lever 7 causes the driven lever 714 to swing clockwise about the driven lever center shaft 72A as shown in FIG. 3.

When the driven lever 714 swings, the projection 71 moves to the right, as seen in FIGS. 3 and 4, and the biasing force of the biasing spring 711 causes the gear arm 44 to rotate counterclockwise. As a result, the segment gear 33 and the gear portion 442 of the gear arm 44 disengage from each other, thereby making the tilt angle of the tilt head 4 adjustable. Also, the pusher plate 73 swings to the position shown in two-dot line in FIG. 3 thereby pushing the pusher rod 77 leftward, as seen in FIG. 3, opposing the biasing forces of the biasing springs 741 to the position shown in two-dot line in FIG. 11.

When the pusher rod 77 moves leftward, the swing arm 62 and the swing lever 67 swing clockwise. As a result, the first and second wedges 63 and 64 positioned close to each other as shown in FIGS. 8 and 9 move away from each other causing the movable column member 3 to be unclamped. Also, the engagement teeth 691 of the second toothed member 69 and the engagement teeth 681 of the first toothed member 68 disengage from each other causing the positive column clamp 66 to be released.

In the bias direction reversing mechanism 81, when the centers of the engagement recess 471, center shaft 811 and engagement pin 821 are aligned on a straight line during unclamping operations of the tilt head clamp 41, column clamp 6 and positive column clamp 66, the direction in which the control lever 7 is biased by the biasing spring 715 changes from clockwise (the direction denoted by the hollow arrow Fb) to counterclockwise (the direction denoted by the filled arrow Fc).

Therefore, the biasing force of the biasing spring 715 is added to the force used to make the pusher plate 73 for the column clamp 6 and positive column clamp 66 push the pusher rod 77 in opposing the biasing forces of the biasing springs 741. This reduces the force the driver is required to use to move the control lever 7 toward the steering wheel 92.

When the control lever 7 reaches the end position b for unclamping as shown in FIG. 14(2), the engagement projection 871 at an edge of the swing lever retention spring 87 engages the engagement projection 86 of the swing lever 82, so that the control lever 7 is securely held in the end position b for unclamping. This allows the driver to release the control lever 7 and adjust, holding the steering wheel 92 with both hands, the position in the front-rear direction and the tilt angle of the steering wheel 92 with ease.

When the driver finishes adjusting the position in the front-rear direction and the tilt angle of the steering wheel 92, the driver releases one hand from the steering wheel 92 and moves, with the released hand, the control lever 7. As the control lever 7 moves clockwise, the steep slope 862 of the engagement projection 86 formed on the swing lever 82 slides over and beyond the engagement projection 871 of the swing lever retention spring 87 causing the gentle slope 861 of the engagement projection 86 to subsequently slide along the engagement projection 871 of the swing lever retention spring 87.

In the bias direction reversing mechanism 81, when the centers of the engagement recess 471, center shaft 811 and engagement pin 821 are aligned on a straight line during clamping operations of the tilt head clamp 41, column clamp 6 and positive column clamp 66, the direction in which the control lever 7 is biased by the biasing spring 715 changes from counterclockwise (the direction denoted by the filled arrow Fc) to clockwise (the direction denoted by the hollow arrow Fb). As a result, the biasing force of the biasing spring 715 causes the control lever 7 to move clockwise, so that the force required to move the control lever 7 is reduced.

As the control lever 7 moves clockwise, the driven lever 714 biased by the biasing spring 715 swings counterclockwise about the driven lever center shaft 72A, causing the projection 71 to move leftward as seen in FIG. 3 and the segment gear 33 and the gear portion 442 of the gear arm 44 to engage each other. As a result, the tilt head 4 is clamped to the movable column member 3. At the same time, the pusher plate 73 swings to the position shown in solid line in FIGS. 3 and 11, and the biasing forces of the biasing springs 741 cause the pusher rod 77 to return, by moving rightward as seen in FIG. 11, to the position shown in solid line in FIG. 11.

When the pusher rod 77 moves rightward, the swing arm 62 swings counterclockwise. As a result, the first and second wedges 63 and 64 shown in FIGS. 8 and 9 move closer to each other causing the movable column member 3 to be clamped. Also, the swing lever 67 swings counterclockwise causing the engagement teeth 691 of the second toothed member 69 and the engagement teeth 681 of the first toothed member 68 to engage each other. This completes a clamping operation of the positive column clamp 66.

Even after the control lever 7 is released, the biasing force of the biasing spring 715 included in the bias direction reversing mechanism 81 holds the control lever 7 in the end position a for clamping, so that the column clamp 6, positive column clamp 66, and tilt head clamp 41 are kept in a clamping state.

When unclamped by the tilt head clamp 41, the tilt head 4 is subjected, like when a person hangs his or her head down, to a downward force attributable to its weight. A rather strong spring 45 (FIGS. 3 to 5) is provided to counterbalance the downward force. The spring 45 that counterbalances the downward force may also be used to provide the tilt head 4 with a force for holding the steering wheel 92 in a highest inclined position to allow the driver to get on or off the vehicle with ease.

Even though, in the above embodiments, the first toothed member 68 is attached to the fixed column member 2 and the second toothed member 69 is attached to the movable column member 3, the first toothed member 68 may be attached to the movable column member 3 and the second toothed member 69 may be attached to the fixed column member 2.

Even though, in the above embodiments, to make up for an engagement displacement between the first and second toothed members 68 and 69, the second toothed member 69 slides in parallel with the center axis of the first toothed member 68, the first toothed member 68 may be made to axially slide instead of the second toothed member 69.

Even though, in the above embodiments, the present invention is applied to a steering device having a tilt head clamp and a column clamp, the present invention may be applied to a steering device having a column clamp and no tilt head clamp.

What is claimed is:

1. A steering device, comprising:
a fixed column member having a body attaching part for attaching the steering device to a vehicle body,
a movable column member fitted to the fixed column member telescopically movably in a vehicle front-rear direction,
a steering shaft which is rotatably supported by the movable column member and to one end of which a steering wheel is fixed, and
a column clamp for clamping and unclamping the movable column member to and from the fixed column member at a desired telescopic position, further
a first toothed member on which a plurality of engagement teeth are formed over a longitudinal length at least equal to a distance over which the telescopic position is adjustable,
a second toothed member having at least one engagement tooth engageable with the engagement teeth of the first toothed member, and
an engagement control member for engaging and disengaging the second toothed member with and from the first toothed member,
wherein the first toothed member is provided on one of the fixed column member and the movable column member and the second toothed member is provided on the other of the fixed column member and the movable column member, and
wherein one of the first toothed member and the second toothed member is movable relative to one of the fixed column member and the movable column member by a distance equivalent to a pitch of the engagement teeth of the first toothed member.

2. A steering device according to claim 1,
wherein the engagement teeth of the first and second toothed members engage each other with an angle smaller than a friction angle for preventing disengagement of the teeth when an impact of a secondary collision is applied.

3. A steering device according to claim 1,
wherein the second toothed member is swingable about and slidable along an axis parallel to a center axis of the fixed column member.

4. A steering device according to claim 1,
wherein the first toothed member is provided with a predetermined range of rotational play about the axis parallel to the center axis of the fixed column member.

5. A steering device according to claim 1,
wherein the steering device further comprises a single control lever for interlockingly controlling the column clamp and the engagement control member.

6. A steering device according to claim 1,
wherein the column clamp has a movable wedge and a fixed wedge each having a slope, the slopes of the movable wedge and the fixed wedge engaging each other to clamp and unclamp the movable column member to and from the fixed column member at a desired telescopic position.

7. A steering device according to claim 6,
wherein the first toothed member is provided with a predetermined distance of play in a direction of the column clamp pressing.
